(19) United States
(12) Patent Application Publication
(10) Pub. No.: US 2026/0250186 A1
(43) Pub. Date: Aug. 27, 2026

(54) METHOD FOR COATING GLASS SUBSTRATE

(71) Applicant: Skytech Inc., Hsinchu County (TW)

(72) Inventors: KUO-JU LIU, Hsinchu County (TW); TA-HAO KUO, Hsinchu County (TW); YAO-SYUAN CHENG, Hsinchu County (TW); ZHI-KAI HUANG, Hsinchu County (TW); CHING-LIANG YI, Hsinchu County (TW)

(21) Appl. No.: 19/199,358

(22) Filed: May 5, 2025

(30) Foreign Application Priority Data
Feb. 21, 2025 (TW) 114106609

(51) Int. Cl. C03C 17/36

(52) U.S. Cl. CPC C03C 17/3607; C03C 17/3649; C03C 2217/258; C03C 2218/151; C03C 2218/152; C03C 2218/31

(57) ABSTRACT

The disclosure is a method for coating a glass substrate, comprising the following steps: cleaning a glass substrate, and pre-treating the surface of the glass substrate with plasma. An intermediate layer is formed on the surface of the glass substrate by chemical vapor deposition or atomic layer deposition, and then the glass substrate is transported to a physical vapor deposition chamber to form a titanium metal conductive layer on the surface of the intermediate layer. Through the coating method described in the disclosure, the adhesion between the titanium metal conductive layer and the glass substrate can be increased, and it is beneficial to improve the yield and reliability of the subsequent packaging process.

### CROSS-REFERENCE TO RELATED APPLICATIONS

This non-provisional application claims priority claim under 35 U.S.C. § 119(a) on Taiwan Patent Application No. 114106609 filed Feb. 21, 2025, the entire contents of which are incorporated herein by reference.

### TECHNICAL FIELD

This disclosure is a method for coating a glass substrate, which can increase the adhesion between a titanium metal conductive layer and the glass substrate, and is beneficial to improve the yield and reliability of subsequent packaging processes.

### BACKGROUND

Semiconductor packaging typically involves the process of mounting small, semiconductor dies onto a packaging substrate, followed by the encapsulation of the dies and substrate within a package housing. This assembly enables the dies to be electrically connected to external circuitry via the packaging substrate, facilitating their operational functionality.

Specifically, the packaging substrate serves to provide structural support and protection for the semiconductor die, and prevents the die from being damaged during transportation and use. The conductive layer disposed on the packaging substrate can be used to connect the electrodes of the die with external circuits, so as to realize the transmission of electrical signals between the die and external circuits. In addition, the packaging substrate can also be used to transfer the heat generated during the operation of the die to the outside to prevent the die from overheating.

Conventionally, organic materials are widely employed for packaging substrate fabrication, offering benefits such as cost-effectiveness and ease of production. Compared with substrates made of organic materials, glass substrates play an increasingly important role in the field of semiconductor packaging due to their excellent properties, such as high heat resistance, high flatness, low coefficient of thermal expansion, high transparency, low dielectric constant, and high mechanical strength. These properties render them particularly advantageous for applications in 5G communications, high-performance computing chipsets, and electric vehicle technologies.

However, glass substrates present challenges including increased cost, heightened processing complexity, and reduced interfacial adhesion with metals. For instance, in the case of depositing a titanium metal conductive film onto a glass substrate surface, the adhesive strength between the titanium film and the glass substrate is limited to approximately 0.05 kgf, which may cause the titanium metal conductive layer to peel off the surface of the glass substrate, thereby affecting the yield and reliability of subsequent packaging processes.

### SUMMARY

In order to solve the problems described in the prior art, this invention proposes a method for coating a glass substrate, which forms an intermediate layer on the surface of the glass substrate, and then forms a titanium metal conductive layer on the intermediate layer. Through the setting of the intermediate layer, the adhesion between the titanium metal conductive layer and the glass substrate can be improved, and it is beneficial to improve the yield and reliability of subsequent packaging processes.

One object of the invention is to provide a method for coating a glass substrate, wherein the surface of the glass substrate undergoes an oxygen plasma pre-treatment prior to the formation of both an intermediate layer and a titanium metal conductive film. This pretreatment facilitates surface modification of the glass substrate and reduces surface dangling bonds, thereby enabling the subsequent sequential deposition of the intermediate layer and the titanium film.

One object of the invention is to provide a method for coating a glass substrate. Due to the large difference in surface energy between the glass substrate and the titanium metal conductive layer, the titanium metal conductive layer is not easy to grow on the surface of the glass substrate, and may lead to uneven thickness of the titanium metal conductive layer grown on the surface of the glass substrate.

Furthermore, a significant mismatch exists in the coefficient of thermal expansion between the glass substrate and the titanium metal conductive film. This disparity can lead to delamination of the titanium film from the glass substrate under substantial ambient temperature variations. Therefore, the invention further provides an intermediate layer between the glass substrate and the titanium metal conductive layer. This intermediate layer effectively reduces the adverse effects stemming from the substantial differences in surface energy and thermal expansion coefficients, thereby facilitating uniform titanium film growth and enhancing its adhesive strength to the glass substrate.

To achieve the foregoing objectives, this disclosure provides a method for coating a glass substrate, comprising: cleaning a glass substrate; transferring the glass substrate to a deposition chamber and depositing an intermediate layer on the glass substrate, wherein the deposition chamber is a chemical vapor deposition chamber or an atomic layer deposition chamber, and the intermediate layer includes a titanium oxide thin film, a titanium nitride thin film, a titanium fluoride thin film, a titanium chloride thin film, a silicon dioxide thin film, or a silicon nitride thin film; and transferring the glass substrate to a first physical vapor deposition chamber and depositing a titanium metal conductive layer on the surface of the intermediate layer.

This disclosure provides another method for coating a glass substrate, comprising: cleaning a glass substrate; transferring the glass substrate to a plasma pre-treatment chamber and pre-treating the glass substrate with an oxygen plasma; transferring the glass substrate to a deposition chamber and depositing an intermediate layer on the glass substrate, wherein the deposition chamber is a chemical vapor deposition chamber or an atomic layer deposition chamber, and the intermediate layer includes a titanium oxide thin film, a titanium nitride thin film, a titanium fluoride thin film, a titanium chloride thin film, a silicon dioxide thin film, or a silicon nitride thin film; and transferring the glass substrate to a first physical vapor deposition chamber and depositing a titanium metal conductive layer on the surface of the intermediate layer.

The method for coating a glass substrate described in the invention has the following advantages: enhanced adhesive strength between the titanium metal conductive film and the glass substrate, leading to improved yield and reliability in subsequent packaging operations.

### BRIEF DESCRIPTION OF THE DRAWINGS

FIG. 1 is a flowchart of a method for coating a glass substrate according to an embodiment of the invention.

FIG. 2 is a structural diagram of a glass substrate with a metal thin film according to an embodiment of the invention.

FIG. 3 is a structural diagram of a deposition equipment for coating a glass substrate according to an embodiment of the invention.

FIG. 4 is a flowchart of a method for coating a glass substrate according to another embodiment of the invention.

### DETAILED DESCRIPTION

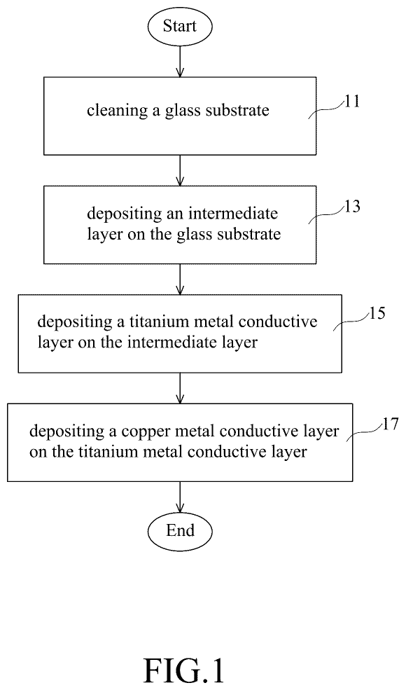

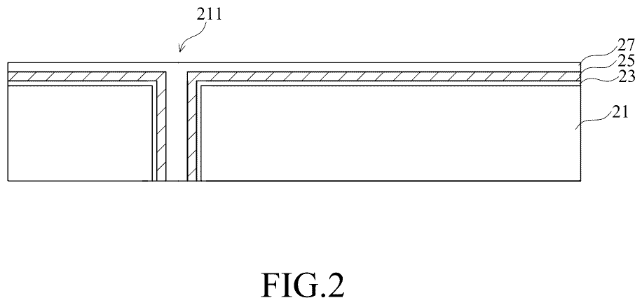

FIG. 1 is a flowchart of a method for coating a glass substrate according to an embodiment of the invention. Please refer to FIG. 2, clean the glass substrate 21, as shown in step 11.

In one embodiment of the invention, the glass substrate 21 may include silicon dioxide, aluminosilicate, alkali-aluminosilicate, borosilicate, alkali-borosilicate, aluminoborosilicate, alkali-aluminoborosilicate, soda-lime, etc. For example, the glass substrate 21 includes 70% or 75% or more of silicon dioxide, and the thickness of the glass substrate 21 may be less than or equal to 3 mm.

In practical applications, the glass substrate 21 may be first subjected to wet cleaning, for example, cleaning the glass substrate 21 with acetone to remove grease or other organic contaminants on the surface of the glass substrate, and then cleaning the glass substrate 21 with methanol to dissolve the acetone remaining on the surface of the glass substrate 21, and finally cleaning the glass substrate 21 with deionized water to remove the organic solvent remaining on the surface of the glass substrate 21.

The above method of cleaning the glass substrate 21 and using acetone and methanol to clean the glass substrate 21 is only an embodiment of the invention and is not a limitation of the scope of the invention. In other embodiments, other organic solvents can also be used to clean the glass substrate 21. For example, the alkaline cleaning solution may be a sodium hydroxide or ammonia solution, and the acidic cleaning solution may be a mixture of sulfuric acid and hydrogen peroxide, nitric acid, or hydrochloric acid.

Following the wet cleaning of the glass substrate 21, a subsequent heating process can be employed to eliminate residual moisture from the substrate surface. In operational practice, prior to the heating process of the glass substrate 21, a high-pressure nitrogen gas gun may be utilized to expel the majority of surface moisture.

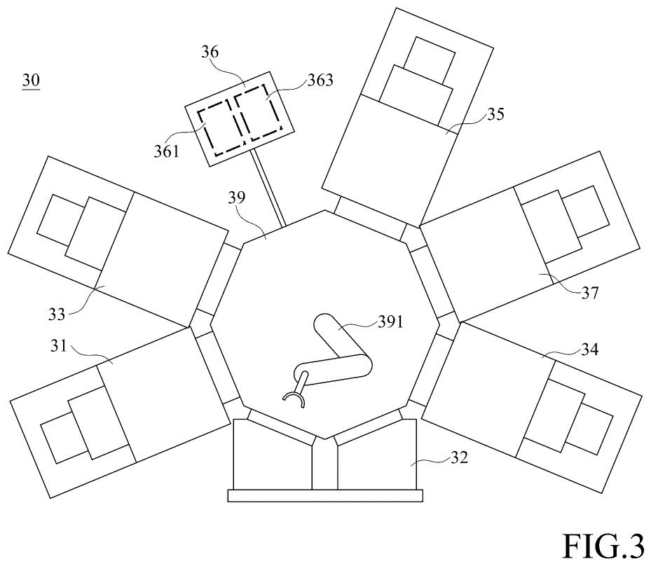

In practical applications, the deposition equipment 30, as shown in FIG. 3, may be employed to deposit coatings onto the glass substrate 21. For example, the deposition equipment 30 may include a plasma pre-treatment chamber 31, a load lock chamber 32, a deposition chamber 33, a pre-cleaning chamber 34, a first physical vapor deposition chamber 35, a second physical vapor deposition chamber 37, and/or a transfer chamber 39. The transfer chamber 39 connects the plasma pre-treatment chamber 31, the load lock chamber 32, the deposition chamber 33, the pre-cleaning chamber 34, the first physical vapor deposition chamber 35, and/or the second physical vapor deposition chamber 37. At least one robotic arm 391 can be arranged in the transfer chamber 39. The robotic arm 391 is used to transfer the glass substrate 21 between the plasma pre-treatment chamber 31, the load lock chamber 32, the deposition chamber 33, the pre-cleaning chamber 34, the first physical vapor deposition chamber 35, and/or the second physical vapor deposition chamber 37.

In one embodiment of the invention, the glass substrate 21 can be transported from the outside of the deposition equipment 30 to the load lock chamber 32. Subsequently, the glass substrate 21 in the load lock chamber 32 is transported to the pre-cleaning chamber 34 by the robotic arm 391 in the transfer chamber 39.

The pre-cleaning chamber 34 can remove contaminants from the surface of the glass substrate 21 through gas or low-energy argon ions. In addition, a heating device may be arranged in the pre-cleaning chamber 34 to heat the glass substrate 21 to remove moisture from the glass substrate 21. In another embodiment of the invention, the pre-cleaning chamber 34 may be independent of the deposition equipment 30 and located outside the deposition equipment 30.

The glass substrate 21 after pre-cleaning will be transferred to the deposition chamber 33, and an intermediate layer 23 will be formed on the surface of the glass substrate 21, as shown in step 13. For example, the glass substrate 21 in the pre-cleaning chamber 34 can be transferred to the deposition chamber 33 through the robotic arm 391 in the transfer chamber 39. The deposition chamber 33 can be configured as a chemical vapor deposition (CVD) chamber, a plasma-enhanced chemical vapor deposition (PECVD) chamber, or an atomic layer deposition (ALD) chamber.

Specifically, when the deposition chamber 33 is a chemical vapor deposition chamber, a titanium-containing gaseous compound and a reaction gas can be delivered into the deposition chamber 33 during the deposition process. For example, the titanium-containing gaseous compound may be titanium tetrachloride (TiCl4), wherein titanium tetrachloride (TiCl4) decomposes at high temperature to generate titanium atoms or titanium molecules, and the titanium atoms or titanium molecules react with the reaction gas to form the intermediate layer 23 on the surface of the glass substrate 21. In different embodiments, a silicon-containing gaseous compound and a reaction gas can be delivered into the deposition chamber 33 to form the intermediate layer 23. For example, the silicon-containing gaseous compound may be silicon tetrachloride (SiCl4).

When the deposition chamber 33 is an atomic layer deposition chamber, a titanium precursor and a reaction gas can be sequentially delivered to the atomic layer deposition chamber during the deposition process to form the intermediate layer 23 on the surface of the glass substrate 21. In different embodiments, a silicon-containing precursor gas and a reaction gas can be delivered into the deposition chamber 33 to form the intermediate layer 23. For example, the silicon precursor gas may be silicon tetrachloride.

In one embodiment of the invention, the reaction gas may be water vapor, oxygen, nitrogen, fluorine, or chlorine, and the intermediate layer 23 formed on the surface of the glass substrate 21 may be a titanium oxide thin film, a titanium nitride thin film, a titanium fluoride thin film, a titanium chloride thin film, a silicon dioxide thin film, or a silicon nitride thin film, etc.

After completing the deposition of the intermediate layer 23, the glass substrate 21 can be transferred to the first physical vapor deposition chamber 35, and a titanium metal conductive layer 25 can be formed on the surface of the intermediate layer 23 of the glass substrate 21 by physical vapor deposition, as shown in step 15. For example, the glass substrate 21 in the deposition chamber 33 can be transferred to the first physical vapor deposition chamber 35 through the robotic arm 391 in the transfer chamber 39.

In one embodiment of the invention, the transfer chamber 39 may be coupled to a pressure adjustment unit 36, and the pressure inside the transfer chamber 39 can be adjusted by the pressure adjustment unit 36. Specifically, the pressure adjustment unit 36 may include a vacuum pump 361 and a gas supply unit 363, wherein the vacuum pump 361 is used to extract gas from the transfer chamber 39 to reduce the pressure inside the transfer chamber 39. The gas supply unit 363 can be used to transport gas into the transfer chamber 39, for example, the gas can be an inert gas, to increase the pressure inside the transfer chamber 39.

Generally, the operational pressure within the deposition chamber 33 is maintained at a level lower than that of both the first physical vapor deposition (PVD) chamber 35 and the atomic layer deposition (ALD) chamber. For instance, the pressure in the deposition chamber 33 generally ranges from 10⁻⁶ to 10⁻³ Torr, whereas the pressure in the first PVD chamber 35 and the ALD chamber is typically below 1 Torr.

Before opening a valve that interconnects the deposition chamber 33 and the transfer chamber 39, the pressure adjustment unit 36 can initially decrease the pressure within the transfer chamber 39. This equalization process ensures that the pressures of both the deposition chamber 33 and the transfer chamber 39 are closely aligned, subsequently enabling the valve connecting to the deposition chamber 33 to be opened. For example, the vacuum pump 361 can be employed to evacuate gas from the transfer chamber 39, thereby achieving a pressure range between 10⁻⁶ to 10⁻³ Torr.

Before opening the valves connecting the first physical vapor deposition chamber 35 and the second physical vapor deposition chamber 37, the pressure adjustment unit 36 can first increase the pressure in the transfer chamber 39, so that the gas pressure of the first physical vapor deposition chamber 35 and the second physical vapor deposition chamber 37 will be similar to that of the transfer chamber 39, and then open the valves connecting the first physical vapor deposition chamber 35 or the second physical vapor deposition chamber 37. For example, gas is transported into the transfer chamber 39 through the gas supply unit 363, so that the pressure in the transfer chamber 39 is slightly less than 1 Torr.

Subsequent to the deposition of the titanium metal conductive layer 25, the glass substrate 21 is conveyed into the second physical vapor deposition (PVD) chamber 37. Within this chamber, a copper metal conductive layer 27 will be formed on the surface of the titanium metal conductive layer 25 of the glass substrate 21 by physical vapor deposition, as shown in step 17. For example, the glass substrate 21 in the first physical vapor deposition chamber 35 may be transferred to the second physical vapor deposition chamber 37 through the robotic arm 391 in the transfer chamber 39.

In practical applications, the glass substrate 21 may include at least one through hole 211, and the intermediate layer 23, the titanium metal conductive layer 25, and the copper metal conductive layer 27 may be sequentially disposed on the surface of the glass substrate 21 and the inner surface of the through hole 211.

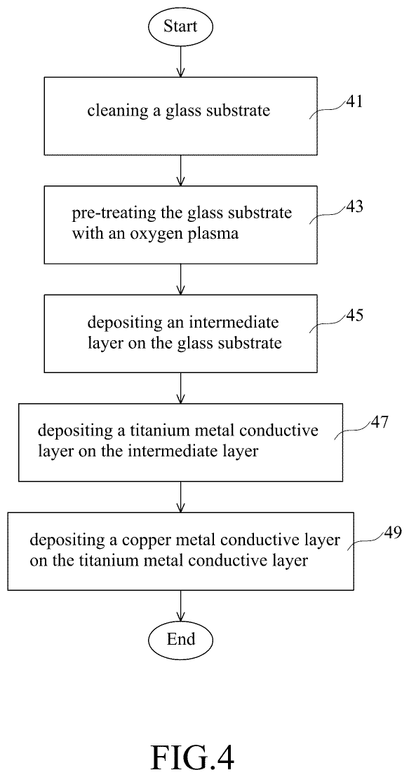

FIG. 4 is a flowchart of the method for coating a glass substrate according to another embodiment of the invention. Please refer to FIG. 2, clean the glass substrate 21, as shown in step 41.

The method of cleaning the glass substrate 21 may be the same as step 11 in FIG. 1. This involves, for example, utilizing acetone to eliminate surface grease and other organic contaminants, followed by a methanol rinse to dissolve residual acetone. A final rinse with deionized water is then conducted to remove any remaining organic solvents from the glass substrate 21 surface.

In one embodiment of the invention, as shown in FIG. 3, the glass substrate 21 may be transported from the outside of the deposition equipment 30 to the load lock chamber 32, and then the glass substrate 21 in the load lock chamber 32 is transported to the pre-cleaning chamber 34 by the robotic arm 391 in the transfer chamber 39. The pre-cleaning chamber 34 is capable of eliminating surface contaminants from the glass substrate 21 utilizing either gaseous species or low-energy argon ions.

Following the pre-cleaning process, the glass substrate 21 is conveyed to the plasma pre-treatment chamber 31, where it undergoes an oxygen plasma pre-treatment on its surface, as shown in step 43. Specifically, the oxygen plasma induces surface modification, thereby lowering the contact angle and transitioning the glass substrate 21 surface from a hydrophobic to a hydrophilic state, which facilitates the subsequent deposition of the intermediate layer 23 and the titanium metal conductive layer 25.

Furthermore, the oxygen plasma treatment serves to mend dangling bonds present on the glass substrate 21 surface, thereby enhancing the suitability for subsequent deposition of the intermediate layer 23 and the titanium metal conductive layer 25.

Subsequent to the plasma pre-treatment, the glass substrate 21 is conveyed to the deposition chamber 33. Within this chamber, the intermediate layer 23 is formed on the surface of the glass substrate 21 utilizing chemical vapor deposition (CVD), as shown in step 45. For example, the glass substrate 21 in the plasma pre-treatment chamber 31 can be transferred to the deposition chamber 33 through the robotic arm 391 in the transfer chamber 39.

After completing the deposition of the intermediate layer 23, the glass substrate 21 will be transferred to the first physical vapor deposition chamber 35, and a titanium metal conductive layer 25 will be formed on the surface of the intermediate layer 23 of the glass substrate 21 by physical vapor deposition, as shown in step 47. For example, the glass substrate 21 in the deposition chamber 33 can be transferred to the first physical vapor deposition chamber 35 through the robotic arm 391 in the transfer chamber 39.

After completing the deposition of the titanium metal conductive layer 25, the glass substrate 21 will be transferred to the second physical vapor deposition chamber 37, and a copper metal conductive layer 27 will be formed on the surface of the titanium metal conductive layer 25 of the glass substrate 21 by physical vapor deposition, as shown in step 49. For example, the glass substrate 21 in the first physical vapor deposition chamber 35 can be transferred to the second physical vapor deposition chamber 37 through the robotic arm 391 in the transfer chamber 39.

The method for depositing metal conductive films on a glass substrate 21, as disclosed herein, enables the sequential formation of the intermediate layer 23, the titanium metal conductive layer 25, and the copper metal conductive film 27 within a single deposition equipment 30. The incorporation of the intermediate layer 23 significantly enhances the adhesion strength between the titanium metal conductive layer 25 and the glass substrate 21. For example, the adhesion force may be improved from 0.05 kgf, as observed in prior art techniques, to 0.5 kgf, thereby substantially reducing the risk of delamination of the titanium metal conductive layer 25 from the glass substrate 21. This enhanced adhesion contributes to improved yield and reliability in subsequent packaging processes.

The foregoing descriptions are merely preferred embodiments of this disclosure, and are not intended to limit the scope of this disclosure, that is, all equivalent changes and modifications made according to shapes, structures, features and spirits described in the scope of the claims of this disclosure shall fall within the scope of the claims of this disclosure.

What is claimed is:

1. A method for coating a glass substrate, comprising:
cleaning a glass substrate;
transferring the glass substrate to a deposition chamber and depositing an intermediate layer on the glass substrate, wherein the deposition chamber is a chemical vapor deposition chamber or an atomic layer deposition chamber, and the intermediate layer includes a titanium oxide thin film, a titanium nitride thin film, a titanium fluoride thin film, a titanium chloride thin film, a silicon dioxide thin film, or a silicon nitride thin film; and
transferring the glass substrate to a first physical vapor deposition chamber and depositing a titanium metal conductive layer on the intermediate layer.

2. The method for coating a glass substrate as claim 1, further comprising: transferring the glass substrate to a second physical vapor deposition chamber and depositing a copper metal conductive layer on the titanium metal conductive layer.

3. The method for coating a glass substrate as claim 2, wherein the glass substrate includes at least one through hole, and the through hole contains the intermediate layer, the titanium metal conductive layer, and the copper metal conductive layer.

4. The method for coating a glass substrate as claim 2, wherein the deposition chamber, the first physical vapor deposition chamber, and the second physical vapor deposition chamber are connected to a transfer chamber, and the glass substrate is transferred between the deposition chamber, the first physical vapor deposition chamber, and the second physical vapor deposition chamber by at least one robotic arm within the transfer chamber.

5. The method for coating a glass substrate as claim 4, further comprising: adjusting a pressure within the transfer chamber by a pressure adjustment unit, so that the pressure within the transfer chamber is similar to the pressure within the deposition chamber or the first physical vapor deposition chamber or the second physical vapor deposition chamber.

6. A method for coating a glass substrate, comprising:
cleaning a glass substrate;
transferring the glass substrate to a plasma pre-treatment chamber and pre-treating the glass substrate with an oxygen plasma;
transferring the glass substrate to a deposition chamber and depositing an intermediate layer on the glass substrate, wherein the deposition chamber is a chemical vapor deposition chamber or an atomic layer deposition chamber, and the intermediate layer includes a titanium oxide thin film, a titanium nitride thin film, a titanium fluoride thin film, a titanium chloride thin film, a silicon dioxide thin film, or a silicon nitride thin film; and
transferring the glass substrate to a first physical vapor deposition chamber and depositing a titanium metal conductive layer on the surface of the intermediate layer.

7. The method for coating a glass substrate as claim 6, further comprising: transferring the glass substrate to a second physical vapor deposition chamber and depositing a copper metal conductive layer on the surface of the titanium metal conductive layer.

8. The method for coating a glass substrate as claim 7, wherein the glass substrate includes at least one through hole, and the through hole contains the intermediate layer, the titanium metal conductive layer, and the copper metal conductive layer.

9. The method for coating a glass substrate as claim 7, wherein the plasma pre-treatment chamber, the deposition chamber, the first physical vapor deposition chamber, and the second physical vapor deposition chamber are connected to a transfer chamber, and the glass substrate is transferred between the plasma pre-treatment chamber, the deposition chamber, the first physical vapor deposition chamber, and the second physical vapor deposition chamber by at least one robotic arm within the transfer chamber.

10. The method for coating a glass substrate as claim 9, further comprising: adjusting a pressure within the transfer chamber by a pressure adjustment unit, so that the pressure within the transfer chamber is similar to the pressure within the plasma pre-treatment chamber, the deposition chamber, the first physical vapor deposition chamber, or the second physical vapor deposition chamber.
